(19) United States
(12) Patent Application Publication
(10) Pub. No.: US 2004/0150366 A1
(43) Pub. Date: Aug. 5, 2004

(54) Turbocharged Fuel Cell Systems For Producing Electric Power

(76) Inventors: Joseph F Ferrall, Simi Valley, CA (US); Pavel A Sokolov, Redondo Beach, CA (US)

Correspondence Address: SUTHERLAND ASBILL & BRENNAN LLP, 999 PEACHTREE STREET, N.E., ATLANTA, GA, 30309, US

(21) Appl. No.: 10/248,579

(22) Filed: Jan. 30, 2003

(51) Int. Cl. H01M 8/06; H01M 8/12; H02J 7/00

(52) U.S. Cl. 320/101; 429/19; 429/30; 429/20

(57) ABSTRACT

An electric power generation system is provided which comprises (i) a reactor means, such as a CPOX or steam reformer reactor, for converting a hydrocarbon fuel (e.g., a logistic fuel, natural gas, etc.) at least partially into a syngas comprising hydrogen gas; (ii) a turbocharger comprising a compressor for compressing an oxygen-containing gas and which is mechanically coupled to a turbine; and (iii) a fuel cell subsystem, such as a SOFC, for reacting the syngas and the oxygen at an elevated pressure to produce electric power and an exhaust gas, wherein the exhaust gas flows through the turbine of the turbocharger, driving the compressor.

### FEDERAL RESEARCH STATEMENT

The federal government may have certain rights in this invention by virtue of ARO/DARPA Contract No. DAAG55-97-C-0041 awarded to AlliedSignal Aerospace Equipment Systems.

### BACKGROUND OF INVENTION

The present invention relates generally to the field of electric power generation systems using hydrocarbon fuels, and, more particularly, to improved systems and methods using an electric power fuel cell.

It is known that hydrocarbon fuels can be used to produce a fuel gas comprising hydrogen, which then can be used with oxygen to fuel an electric power producing fuel cell system, such as a SOFC. The processes of converting hydrocarbon fuels to a hydrogen-containing gas that have been previously developed generally fall into one of three classes: steam reforming, partial oxidation (catalytic and non-catalytic), and auto-thermal reforming (a combination of steam reforming and partial oxidation). All three hydrocarbon conversion methods have been considered for use in conjunction with fuel cells, particularly in the context of a replacement for internal combustion engines.

Large-scale hybrid power generation systems using gas turbines and compressors with solid oxide fuel cells have been considered for systems of greater than 100 kW in which power is produced both from the SOFC and the turbine/compressor combination.

It would be desirable to provide fuel cell power generation systems for small-scale power applications, particularly with a system that is portable and particularly with a system adapted for use with liquid hydrocarbon fuels, such as logistic fuels for military applications. It would also be advantageous for such systems to exhibit greater efficiencies than provided by presently available fuel cells.

### SUMMARY OF INVENTION

An electric power generation system is provided which comprises (i) a reactor means for converting a hydrocarbon fuel at least partially into a syngas comprising hydrogen gas; (ii) a turbocharger comprising a compressor for compressing an oxygen-containing gas and which is mechanically coupled to a turbine; and (iii) a fuel cell subsystem for reacting the syngas and the oxygen at an elevated pressure to produce electric power and an exhaust gas, wherein the exhaust gas flows through the turbine of the turbocharger, driving the compressor. The system can be adapted for use with a heavy hydrocarbon fuel (e.g., a logistic fuel) or a light hydrocarbon fuel (e.g., natural gas). The oxygen-containing gas can be air, oxygen enriched air, or another gas that includes atomic or molecular oxygen.

In one embodiment, the system has a power production capacity between 0.1 and 500 kW. In another embodiment, the system has a power production capacity between 5 and 50 kW. In yet another embodiment, the system has a power production capacity between 0.1 and 10 kW. In one embodiment, the system is portable.

In one embodiment, the fuel cell subsystem comprises a solid oxide fuel cell (SOFC) for electrochemically reacting the syngas and the oxygen to produce DC electric power. The fuel cell subsystem may further include a combustor for combusting unreacted hydrocarbon fuel, syngas, and oxygen-containing gas flowing from the solid oxide fuel cell.

In one embodiment, the reactor means comprises a catalytic partial oxidation process (CPOX) subsystem. When a heavy hydrocarbon fuel is used, the CPOX subsystem can further include a vaporizer means for vaporizing the heavy hydrocarbon fuel. In an alternative embodiment, the reactor means utilizes a steam reforming process, an auto-thermal process, or a non-catalytic partial oxidation process.

In one embodiment, the electric power generation system further includes a desulfurizer means for removing at least a portion of any sulfur present in the hydrocarbon fuel or syngas before the hydrocarbon fuel or the syngas flows to the fuel cell.

In one embodiment, the system includes at least one heat exchanger means for heating the compressed oxygen-containing gas flowing from the turbocharger before the compressed oxygen-containing gas enters the fuel cell subsystem. For example, the heat exchanger means can transfer heat to the compressed oxygen-containing gas from the exhaust gas. In another embodiment, the system includes at least one heat exchanger means for heating the syngas flowing from the reactor means before the syngas enters the fuel cell. For example, the heat exchanger means can transfer heat to the syngas from the exhaust gas. In yet another embodiment, the system includes a heat exchanger means for transferring heat from the exhaust gas to the reactor means to heat therein the organic fuel, the syngas, or both.

In another aspect of the invention, an electric power generation system is provided which includes (i) a CPOX reactor for converting a hydrocarbon fuel at least partially into a syngas comprising hydrogen gas (H₂) and carbon monoxide (CO); (ii) a turbocharger comprising a compressor for compressing air and which is mechanically coupled to a turbine; (iii) a solid oxide fuel cell for reacting the syngas and oxygen in the air at an elevated pressure to produce electric power and fuel cell product gas; and (iv) a combustor for combusting at least a portion of the fuel cell product gas to yield an exhaust gas, wherein the exhaust gas flows through the turbine of the turbocharger, driving the compressor.

In yet another aspect of the invention, an electric power generation system is provided which includes (i) a steam reformer for converting a hydrocarbon fuel at least partially into a syngas comprising hydrogen gas; (ii) a turbocharger comprising a compressor for compressing air and which is mechanically coupled to a turbine; (iii) a solid oxide fuel cell for reacting the syngas and oxygen in the air at an elevated pressure to produce electric power and fuel cell product gas; and (iv) a combustor for combusting at least a portion of the fuel cell product gas to yield an exhaust gas, wherein the exhaust gas flows through the turbine of the turbocharger, driving the compressor. In one embodiment, a recuperator is included for transferring heat from the exhaust gas discharged from the turbine to the compressed air from the turbocharger.

In another aspect of the invention, a method is provided for producing electric power from a hydrocarbon fuel. The method includes (i) providing a quantity of hydrocarbon fuel to a reactor to convert the hydrocarbon fuel at least partially into a syngas comprising hydrogen gas; (ii) providing a quantity of an oxygen-containing gas to a turbocharger comprising a compressor for compressing the oxygen-containing gas, the compressor being mechanically coupled to a turbine; (iii) feeding the syngas and the compressed oxygen-containing gas to a fuel cell subsystem; and (iv) reacting the syngas and the oxygen at an elevated pressure in the fuel cell subsystem to produce electric power and an exhaust gas, wherein the exhaust gas flows through the turbine of the turbocharger, driving the compressor. In one embodiment of the method, the fuel cell subsystem comprises a solid oxide fuel cell and a combustor. In another embodiment of the method, the reactor comprises a CPOX reactor. The method can further include transferring heat from the exhaust gas to the reactor, the compressed oxygen-containing gas, the syngas, or a combination thereof, using one or more heat exchangers.

In yet another aspect of the invention, a battery charger is provided, which includes one of the electric power generation systems described herein for producing DC electric power, and a means for operably connecting this DC electric power to a battery in need of charging.

### BRIEF DESCRIPTION OF DRAWINGS

FIG. 1 is a process flow diagram of one embodiment of a turbocharged solid oxide fuel cell system, which utilizes a liquid hydrocarbon fuel source.

FIG. 2 is a process flow diagram of another embodiment of a turbocharged solid oxide fuel cell system, which utilizes a natural gas hydrocarbon fuel source.

FIG. 3 is a cross-sectional view of one embodiment of a turbocharger, showing the flow of gases therethrough.

### DETAILED DESCRIPTION

Improved electric power generation systems and methods of use have been developed which employ a turbocharged fuel cell to produce electric power from a syngas that has been generated from a hydrocarbon fuel. The electric power generation system converts the hydrocarbon fuel source to syngas and uses the syngas as a fuel for a fuel cell system. A turbocharger is used to pressurize the fuel cell, to enhance the efficiency of the system, for example, to provide efficiencies of approximately 40 to 50%. The electric power generation system comprises: (i) a reactor means for converting a hydrocarbon fuel at least partially into a syngas comprising hydrogen gas; (ii) a turbocharger comprising a compressor for compressing an oxygen-containing gas and which is mechanically coupled to a turbine; and (iii) a fuel cell subsystem for reacting the syngas and the oxygen at an elevated pressure to produce electric power and an exhaust gas, wherein the exhaust gas flows through the turbine of the turbocharger, driving the compressor.

In a preferred embodiment, the power generation system is a small-scale unit that can utilize a standard, commercially available turbocharger, such as one of the models produced for various transportation markets. In this way, the power generation system can utilize a relatively inexpensive turbine means, unlike conventional, large-scale systems that require retrofitting to specifically designed turbine systems (e.g., where the systems include an entire power generation system such as a microturbine system).

### The Oxygen-Containing Gas and the Hydrocarbon Fuel

As used herein the “oxygen-containing gas” refers to an oxidizer gas source, i.e. a source of oxygen that serves as the oxidant in the oxidative reaction, such as that which will occur in a CPOX reactor. Air is a desirable oxygen-containing gas because of its cost and availability. Nevertheless, oxygen-enriched air, pure oxygen or any other oxidizer source containing oxygen (atomic or molecular) can be utilized.

A variety of hydrocarbon fuel sources can be used with the electric power generation systems described herein. The systems can be adapted for use with liquid or gaseous hydrocarbon fuel sources. In one embodiment, the hydrocarbon fuel comprises a heavy hydrocarbon, which is herein defined as a hydrocarbon molecule having at least six carbon atoms. A “heavy hydrocarbon fuel” is defined as a liquid mixture of heavy hydrocarbons. Representative examples of suitable heavy hydrocarbon fuels include gasoline, kerosene, diesel fuel, and the so-called logistic fuels (e.g., JP-8 jet fuel, JP-4 jet fuel, JP-5 jet fuel, No. 2 fuel oil, and the like). Logistic fuels are of great interest for military applications of the present electric power generation systems, particularly portable power generation systems. In logistic fuels, the number of carbon atoms in a molecule may typically range from at least six and up to about 20 or more. Gasoline typically has a minimum of 80%-90% hydrocarbons with greater than five or more carbon atoms per molecule. The heavy hydrocarbon fuels typically include sulfur, which may be present as inorganic or organic compounds that are dissolved in the fuel. In addition to sulfur, the heavy hydrocarbons may have other heteroatoms in their molecules, such as oxygen, nitrogen, chlorine, other non-metals and metals. The heavy hydrocarbon fuel may include lesser amounts of other compounds or impurities.

In another embodiment, the hydrocarbon fuel comprises a light hydrocarbon, which is herein defined as a hydrocarbon molecule having at from one to four carbon atoms. A “light hydrocarbon fuel” is defined as a gaseous mixture of light hydrocarbons. A preferred light hydrocarbon fuel is natural gas, which typically includes between 87 and 96 mol % methane. Examples of other light hydrocarbon fuels include ethane, propane, n-butane, and mixtures thereof. Natural gas or other light hydrocarbon fuels may include lesser amounts (e.g., less than 2%) of carbon dioxide, water, nitrogen, hydrogen, and C5-C6 hydrocarbons (e.g., pentane, hexane).

The regulated flow rates of both hydrocarbon fuel and oxygen-containing gas are provided to generally regulate the carbon to oxygen ratio. More specifically, the regulated flow rates enable regulation of a molar ratio of carbon atoms to oxygen atoms, with the number of carbon atoms being determined from the carbon content of the hydrocarbon fuel. The number of oxygen atoms is based upon the concentration of oxygen in the oxidizer gas. As is known in the art, the carbon to oxygen (C/O) ratio can affect, for example, various aspects of a CPOX process, including hydrogen and carbon monoxide yields and carbon formation. It typically is useful to have a C/O ratio of at least about 0.5, preferably between about 0.5 and 1.0, and more preferably between about 0.6 and 0.8. Below a C/O ratio of about 0.5, deep oxidation tends to occur, leading to complete as opposed to partial combustion of the hydrocarbon to carbon dioxide and water. Above a C/O ratio of about 1.0, incomplete combustion, coke formation, and side reactions may tend to occur.

### Reactor Means

The reactor means is a fuel processor that converts the hydrocarbon fuel at least partially into a syngas comprising hydrogen gas (H₂), and carbon monoxide (CO) and/or carbon dioxide (CO₂). A variety of technologies are available for converting different hydrocarbon fuels into a suitable syngas for use in the present power generation systems.

In one embodiment, the reactor means comprises a catalytic partial oxidation (CPOX) process. For a power generation system using liquid hydrocarbon fuels (e.g., a heavy hydrocarbon fuel), the CPOX subsystem may include a vaporizer means for vaporizing the liquid hydrocarbon fuel. The vaporizer could be, for example, a conventional heat exchanger, preferably one that captures waste heat from exhaust gas generated by the fuel cell, as will be further described below. One example of a suitable CPOX process is described in U.S. Pat. No. 6,221,280 to Anumakonda, et al., which is incorporated herein by reference in its entirety. Anumakonda teaches a method of processing sulfur-containing heavy hydrocarbon fuels in the substantial absence of steam through catalytic partial oxidation. The process comprises the steps of vaporizing a heavy hydrocarbon fuel and bringing the vaporized fuel and oxidizer mixture in contact with a noble metal catalyst supported on an open channel structure. The process produces essentially complete conversion of hydrocarbons present in the feed to hydrogen and carbon monoxide, which can then be directed to a fuel cell system. Essentially any known CPOX system and process could be adapted for use in the present power generation systems.

In another embodiment, the reactor means comprises a steam reformer. Representative examples of suitable steam reformer systems adaptable for use in the present power generation systems are described in U.S. Pat. No. 5,861,137; U.S. Pat. No. 5,997,594; U.S. Pat. No. 5,938,800; and U.S. Pat. No. 6,221,117, which are incorporated herein by reference in their entirety. Generally, the steam reformer receives steam and one or more hydrocarbon fuels and reacts them over a catalyst at an elevated temperature (e.g., between 250° C. and 800° C.) to produce primarily hydrogen and carbon dioxide. Some trace quantities of unreacted reactants and trace quantities of byproducts such as carbon monoxide also result from steam reforming.

In yet other embodiments, the reactor means can employ an auto-thermal oxidation process, a non-catalytic partial oxidation, or other processes known in the art. See, e.g., U.S. Pat. No. 6,409,974 to Towler et al.; Woods, et al, “Automotive Fuel Processor,” HBT (Hydrogen Burner Technology, Inc.), presented at 2000 Fuel Cell Seminar; Cross, et al, PEM Fuel Cell Power System Technology,” Nuvera Fuel Cells, presented at 2000 Fuel Cell Seminar.

### The Turbocharger

The turbocharger is used to boost the pressure of the oxygen-containing gas flowing to the fuel cell subsystem. For example, the turbocharger can include, or is adapted from, turbochargers known in the art, which typically are used in connection with internal combustion engines, such as for trucks and automobiles (e.g., a GARRETT™ turbocharger, by Garrett Engine Boosting Systems, a division of Honeywell, Inc.). The turbocharger uses energy from hot, pressurized gases to compress another gas used in the process, without generating power at the turbocharger. The step of compressing the gas beneficially increases the process″s power output (elsewhere from the process), increases the process″s efficiency, or both, over that of the process without the turbocharger.

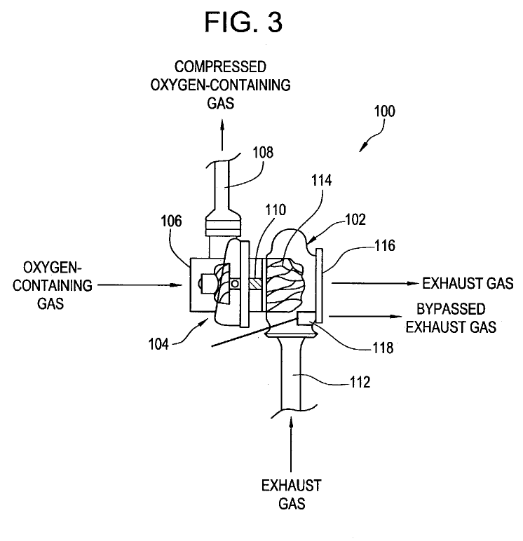

FIG. 3 illustrates a typical turbocharger. It shows turbocharger 100, which includes a turbine 102 and a compressor 104. The air or other oxygen-containing gas is introduced into the compressor 104 through axial inlet 106, and the compressed gas is discharged from radial outlet 108. The compressor 104 is mechanically coupled to the turbine 102 with a shaft 110. The turbine 102 provides all of the power required to drive the compressor 104. The turbine 102 produces no other power. Exhaust gases from a fuel cell subsystem are directed into turbine inlet 112. The exhaust gases flowing through the turbine 102 cause the turbine blades 114 to rotate and thus turn the shaft 110. The exhaust gases then exit the turbine 102 via turbine outlet 116, and can then be exhausted into the atmosphere, with or without first flowing through additional heat recovery devices. In an optional embodiment, the turbocharger 100 includes a wastegate 118, which is a control valve mechanism that can be used to bypass a portion of the exhaust gas around the turbine 102, as may be needed to control the speed of the turbine 102 and thus the speed of the rotary compressor 104.

One skilled in the art can select a suitable turbine and rotary compressor combination based on the gas flow rates (i.e. the oxygen-containing gas and exhaust gas) expected for use with a particular electric power generation system. In one embodiment, the electric power generation system is portable and the oxygen-containing gas is atmospheric air. In one example of such an embodiment, the turbocharger compresses air at ambient temperature and pressure to a pressure between about 14.7 and 20.3 psia (1.0 to 1.4 bar), a temperature between about 77 and 166° F. (25 to 75° C.), and a flow rate between about 90 and 100 lb/hr (41 to 45 kg/hr).

### Fuel Cell Subsystem

The fuel cell subsystem generates electric power from the syngas and the oxygen, at an elevated pressure. Any fuel cell system that can utilize the fuel content of these gases can be employed. Representative examples of fuel cells include, but are not limited to, oxygen-ion conducting solid oxide fuel cells and proton conducting ceramic or polymer membrane fuel cells, in which the electrolyte is a solid.

In a preferred embodiment, the fuel cell subsystem is a solid oxide fuel cell (SOFC) system, as known in the art. The fuel cell system can be constructed according to well-known methods in the art and can have a sulfur tolerant design or can be provided with (or used with) a means for desulfurizing the product gas stream. Representative examples of suitable types of solid oxide fuel cells are described in U.S. Pat. No. 4,770,955; U.S. Pat. No. 4,910,100; U.S. Pat. No. 4,913,982; U.S. Pat. No. 5,549,983; U.S. Pat. No. 5,851,689; U.S. Pat. No. 6,296,962; and U.S. Pat. No. 6,291,089, which are incorporated herein by reference in their entirety.

The fuel cell is essentially a galvanic conversion device that electrochemically reacts a fuel with an oxidant to generate a direct current. The fuel cell typically includes a cathode material, an electrolyte material, and an anode material, where the electrolyte is a non-porous material sandwiched between the cathode and anode materials. As an individual electrochemical cell generates a relatively small voltage, higher (and thus more practical) voltages are obtained by connecting together in series several individual electrochemical cells, for example, to form a stack. Electrical connection between these cells is made via an electrical interconnect between the cathode and anode of adjacent cells. This electrical interconnect also provides for passageways that allow oxidant fluid to flow past the cathode and fuel fluid to flow past the anode, while keeping these fluids separated from one another. The stack generally includes ducts and/or manifolding to conduct the fuel and oxidant into and out of the stack. The typically gaseous fuel and oxidant are continuously passed through separate passageways. Electrochemical conversion occurs at or near the three-phase boundaries of each electrode (cathode and anode) and the electrolyte, such that the fuel is electrochemically reacted with the oxidant to produce a DC electrical output.

### Exemplary Power Generation Systems

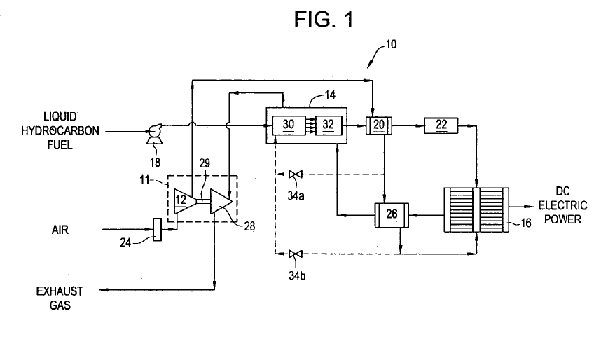

Turning to the drawings in which like reference numerals indicate like parts throughout the views, FIG. 1 illustrates one embodiment of a power generation system, which uses a liquid hydrocarbon fuel source. The power generation system 10 includes a turbocharger 11 (which includes turbocharger compressor 12 and turbocharger turbine 28), catalytic partial oxidation (CPOX) subsystem 14, and solid oxide fuel cell (SOFC) subsystem 16. The system 10 further comprises, or is adapted to be operably connected to, a source of hydrocarbon fuel and a source of air. Air is pulled through air filter 24 and into turbocharger compressor 12, where the air is compressed. The compressed air then flows through an air preheater 20 and then through an air heater 26, before flowing to the SOFC subsystem 16.

A liquid hydrocarbon fuel is pumped by a pump 18 to CPOX subsystem 14, where the liquid fuel is vaporized in vaporizer 30 and then fed to CPOX reactor 32, which converts the hydrocarbon fuel into a syngas, which is rich in carbon monoxide and hydrogen gas. The syngas flows from the CPOX subsystem 14 and through the air preheater 20, where heat from the syngas is used to heat the compressed air. The syngas then flows to desulfurizer 22 to remove at least a portion of the sulfur compounds present in the syngas. (Examples of high temperature desulfurization techniques are described, for, example, in Flytzani-Stephanopoulos & Li, “Kinetics of Sulfidation Reactions Between H2S and Bulk Oxide Sorbents,” Review paper, Proc. NATO-Advanced Study Institute of Hot Coal Gas with Regenerable Metal Oxide Sorbents: New Developments,” Turkey, Jul. 7-19, 1996.) Subsequently, the syngas flows to the SOFC subsystem 16. SOFC subsystem 16 is comprised of a radial solid oxide fuel cell stack and a combustor. The syngas (fuel) and oxygen gas (oxidant) flow into the fuel cell stack, and an electrochemical reaction produces a DC electrical output.

The combustor of the SOFC subsystem 16 combusts the majority of, and preferably substantially all of, the syngas and unreacted hydrocarbon fuel, to yield an exhaust gas comprising water and carbon dioxide. The exhaust gas flows from the SOFC subsystem 16 and through the air heater 26, where heat is transferred from the exhaust gas to the compressed air to heat the compressed air flowing into the SOFC subsystem 16. The exhaust gas then flows to CPOX subsystem 14, where heat is transferred from the exhaust gas to hydrocarbon fuel in the vaporizer 30 and/or the CPOX reactor 32. The exhaust gas finally flows through turbocharger turbine 28, which is mechanically coupled through shaft 29 to the turbocharger compressor 12. The turbine 28 provides all the power required to drive the compressor 12. From the turbine, the exhaust gas is released from the power generation system 10, for example, into the atmosphere. Valves 34a and 34b can be used to control the flow of compressed air and hot compressed air, respectively, to the vaporizer 30 of the CPOX system.

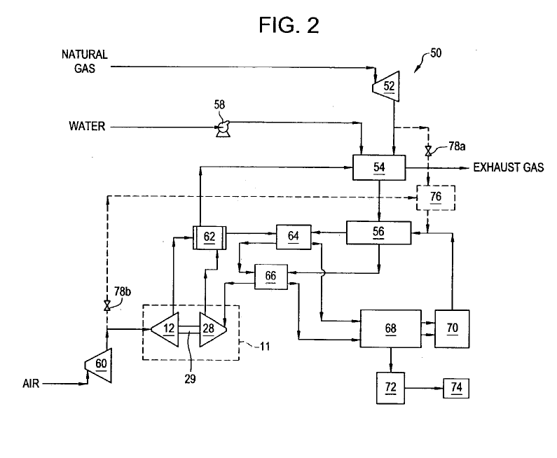

FIG. 2 illustrates a second embodiment of a power generation system, which uses a natural gas hydrocarbon fuel source. The power generation system 50 includes turbocharger 11 (which includes turbocharger compressor 12 and turbocharger turbine 28), steam reformer 56, and solid oxide fuel cell (SOFC) 68. Atmospheric air is directed into the system by air blower or compressor 60 and then directed into the turbocharger compressor 12, where the air is further compressed. The compressed air then flows through a recuperator 62 and then through an air preheater 64, before flowing to the SOFC 16.

The natural gas hydrocarbon fuel is fed through fuel gas compressor 52. The compressed natural gas flowing from the fuel gas compressor 52 then flows into a natural gas preheater/steam generator 54. In addition, water is pumped by water pump 58 into the natural gas preheater/steam generator 54 and converted into steam. A heated mixture of the steam and natural gas then flows from the natural gas preheater/steam generator 54 and into the steam reformer 56, which converts the mixture into a syngas, which comprises hydrogen and carbon monoxide. The syngas flows from the steam reformer 56 and through a reformate preheater 66, which heats the syngas.

The syngas then flows to the SOFC 68, where the syngas (fuel) and oxygen in the compressed air (oxidant) undergo an electrochemical reaction to produce DC electrical power. The DC power is shown in an optional embodiment in which the DC power is directed to an inverter 72, which then feeds AC power to a power grid 74.

The unreacted syngas, unreacted air, and gaseous by-products flow from SOFC 68 to SOFC combustor 70, where these gases are combusted, producing a hot exhaust gas, which flows from the SOFC combustor and through a series of heat exchangers to recover a portion of the heat energy from the exhaust gas. In this embodiment, the exhaust gas flows through the steam reformer 56, where heat is transferred from the exhaust gas to the syngas, and then through air preheater 64, where heat is transferred from the exhaust gas to the compressed air. The exhaust gas then flows from the air preheater 64 and through the reformate preheater 66, where heat is transferred from the exhaust gas to the syngas. Next, the exhaust gas flows through turbocharger turbine 28, which is mechanically coupled through shaft 29 to the turbocharger compressor 12. The turbocharger turbine 28 provides all the power required to drive the turbocharger compressor 12. From the turbine, the exhaust gas flows through recuperator 62 and then through the natural gas preheater/steam generator 54, and finally is released from the power generation system 50, for example, into the atmosphere. Control valves 78a and 78b can be used to control the flow of compressed natural gas and air, respectively, to a start-up combustor 76, which is used to begin operating the power generation system 50.

### Heat Balancing of System

As can be seen from FIGS. 1 and 2, the electric power generation systems and methods described herein preferably include one or more heat exchangers for maximizing energy efficiency and minimizing temperature gradients among the system components and fluids. For example, it is desirable for the reactant temperature at the fuel cell inlet to be close to the operating temperature of the fuel cell. In one embodiment, that temperature is controlled to be between about 750 and 800° C.

In one embodiment, which is illustrated in FIG. 2 described below, four heat exchangers are used to accomplish the desired heat balance. The first one is the recuperator 62, which transfers heat from the turbine exhaust gas to the fresh air supplied to the system. As the temperature of the recuperator cold side outlet is still below the required temperature, and the fresh air is thus directed through a second heat exchanger, air preheater 64, where the fresh air is brought up to the desired temperature by using heat from the hot fuel cell exhaust gas. The fresh air temperature can be controlled, for example, by using a bypass with a control valve, preferably on the cold side of the air preheater 64. The third heat exchanger is the natural gas preheater/steam generator 54, which uses residual heat from the turbine exhaust after it has flowed through the recuperator 62. The natural gas preheater/steam generator 54 heats the natural gas and vaporizes water required for the steam reformer 56. As the temperature of the syngas flowing from steam reformer 56 is also below the fuel cell operating temperature, the syngas is directed through the fourth heat exchanger, the reformate preheater 66. The reformate preheater 66 raises the inlet temperature of the syngas up to the operating temperature using heat from the fuel cell exhaust gas. In addition, heat is transferred from the fuel cell exhaust gas to the reformer 56, as the steam reforming reaction is endothermic and requires heat input. The start-up combustor 76 can provide the initial heat needed to begin operation and approach the steady-state operating temperatures of the system. From the foregoing description, one skilled in the art can readily select other desirable means for exchanging heat and energy among the system components and process streams.

### Applications

The electric power generation systems described herein can be used to produce and provide DC or AC electric power for essentially any need or use. The system can be designed to be portable, or, alternatively, designed to be fixed for use at a single location.

In one embodiment, a battery charger is provided, which includes one of the electric power generation systems described herein for producing DC electric power, and a means for operably connecting the DC electric power to a battery in need of charging (e.g., a battery for use in a transportation vehicle, such as cars, trucks, watercraft, aircraft, and the like). In one embodiment, this battery charger is portable and adapted to use atmospheric air as the oxygen-containing gas and a logistic fuel as the hydrocarbon fuel. In one embodiment, such a battery charger/power generation system has a power production capacity between 0.1 and 10 kW.

In one embodiment, the systems could be used in recharging batteries for small-scale use, portable by a human, particularly a soldier, for example on a battlefield. Such batteries typically have power capacities up to 500 W.

In another embodiment, the DC electric power is inverted and directed to an AC power grid, where the electric power can be routed as needed to serve local and remote users. This embodiment may, for example, be particularly useful with atmospheric air as the oxygen-containing gas and natural gas as the hydrocarbon fuel. In one embodiment, such an electric power generation system has a power production capacity between 5 and 50 kW.

Modifications and variations of the methods and devices described herein will be obvious to those skilled in the art from the foregoing detailed description. Such modifications and variations are intended to come within the scope of the appended claims.

1. An electric power generation system comprising:
a reactor means for converting a hydrocarbon fuel at least partially into a syngas comprising hydrogen gas;
a turbocharger comprising a compressor for compressing an oxygen-containing gas and which is mechanically coupled to a turbine; and
a fuel cell subsystem for reacting the syngas and the oxygen at an elevated pressure to produce electric power and an exhaust gas, wherein the exhaust gas flows through the turbine of the turbocharger, driving the compressor.

2. The system of claim 1, wherein the fuel cell subsystem comprises a solid oxide fuel cell for electrochemically reacting the syngas and the oxygen to produce DC electric power.

3. The system of claim 2, wherein the fuel cell subsystem further comprises a combustor for combusting unreacted hydrocarbon fuel, syngas, and oxygen-containing gas flowing from the solid oxide fuel cell.

4. The system of claim 1, wherein the hydrocarbon fuel comprises a heavy hydrocarbon fuel.

5. The system of claim 4, wherein the heavy hydrocarbon fuel comprises a logistic fuel.

6. The system of claim 1, wherein the reactor means comprises a catalytic partial oxidation process (CPOX) subsystem.

7. The system of claim 6, wherein the hydrocarbon fuel comprises a heavy hydrocarbon fuel and the CPOX subsystem comprises a vaporizer means for vaporizing the heavy hydrocarbon fuel.

8. The system of claim 1, further comprising a desulfurizer means for removing at least a portion of any sulfur present in the hydrocarbon fuel or syngas before the hydrocarbon fuel or the syngas flows to the fuel cell.

9. The system of claim 1, wherein the hydrocarbon fuel comprises natural gas.

10. The system of claim 1, wherein the reactor means utilizes a steam reforming process, an auto-thermal process, or a non-catalytic partial oxidation process.

11. The system of claim 1, further comprising at least one heat exchanger means for heating the compressed oxygen-containing gas, flowing from the turbocharger, before the compressed oxygen-containing gas enters the fuel cell subsystem.

12. The system of claim 11, wherein the heat exchanger means transfers heat to the compressed oxygen-containing gas from the exhaust gas.

13. The system of claim 1, further comprising at least one heat exchanger means for heating the syngas, flowing from the reactor means, before the syngas enters the fuel cell.

14. The system of claim 13, wherein the heat exchanger means transfers heat to the syngas from the exhaust gas.

15. The system of claim 1, further comprising a heat exchanger means for transferring heat from the exhaust gas to the reactor means to heat therein the organic fuel, the syngas, or both.

16. The system of claim 1, having a power production capacity between 0.1 and 500 kW.

17. The system of claim 16, having a power production capacity between 5 and 50 kW.

18. The system of claim 1, which is portable and has a power production capacity between 0.1 and 10 kW.

19. The system of claim 1, wherein the oxygen-containing gas is air.

20. An electric power generation system comprising:
a CPOX reactor for converting a hydrocarbon fuel at least partially into a syngas comprising hydrogen gas (H₂) and carbon monoxide (CO);
a turbocharger comprising a compressor for compressing air and which is mechanically coupled to a turbine;
a solid oxide fuel cell for reacting the syngas and oxygen in the air at an elevated pressure to produce electric power and fuel cell product gas; and
a combustor for combusting at least a portion of the fuel cell product gas to yield an exhaust gas, wherein the exhaust gas flows through the turbine of the turbocharger, driving the compressor.

21. The system of claim 20, further comprising at least one heat exchanger means for transferring heat from the exhaust gas to the compressed air, the hydrocarbon fuel, the syngas, or a combination thereof.

22. The system of claim 20, wherein the hydrocarbon fuel comprises a heavy hydrocarbon fuel.

23. The system of claim 22, which is portable.

24. The system of claim 20, wherein the combustor combusts a majority of the fuel cell product gas.

25. An electric power generation system comprising:
a steam reformer for converting a hydrocarbon fuel at least partially into a syngas comprising hydrogen gas;
a turbocharger comprising a compressor for compressing air and which is mechanically coupled to a turbine;
a solid oxide fuel cell for reacting the syngas and oxygen in the air at an elevated pressure to produce electric power and fuel cell product gas; and
a combustor for combusting at least a portion of the fuel cell product gas to yield an exhaust gas, wherein the exhaust gas flows through the turbine of the turbocharger, driving the compressor.

26. The system of claim 25, further comprising at least one heat exchanger means for transferring heat from the exhaust gas to the compressed air, the hydrocarbon fuel, the syngas, or a combination thereof.

27. The system of claim 26, comprising a recuperator for transferring heat from the exhaust gas discharged from the turbine to the compressed air from the turbocharger.

28. The system of claim 25, wherein the hydrocarbon fuel comprises natural gas.

29. A method of producing electric power from a hydrocarbon fuel comprising:
providing a quantity of hydrocarbon fuel to a reactor to convert the hydrocarbon fuel at least partially into a syngas comprising hydrogen gas;
providing a quantity of an oxygen-containing gas to a turbocharger comprising a compressor for compressing the oxygen-containing gas, the compressor being mechanically coupled to a turbine;
feeding the syngas and the compressed oxygen-containing gas to a fuel cell subsystem; and
reacting the syngas and the oxygen at an elevated pressure in the fuel cell subsystem to produce electric power and an exhaust gas, wherein the exhaust gas flows through the turbine of the turbocharger, driving the compressor.

30. The method of claim 29, wherein the hydrocarbon fuel comprises a heavy hydrocarbon fuel.

31. The method of claim 29, wherein the hydrocarbon fuel comprises natural gas.

32. The method of claim 29, wherein the fuel cell subsystem comprises a solid oxide fuel cell and a combustor.

33. The method of claim 29, wherein the reactor comprises a CPOX reactor.

34. The method of claim 29, wherein the oxygen-containing gas is air.

35. The method of claim 29, further comprising transferring heat from the exhaust gas to the reactor, the compressed oxygen-containing gas, the syngas, or a combination thereof, using one or more heat exchangers.

36. A battery charger comprising:
the electric power generation system of claim 20, which produces DC electric power; and
a means for operably connecting said DC electric power to a battery in need of charging.
